(19) United States
(12) Patent Application Publication
(10) Pub. No.: US 2025/0218206 A1
(43) Pub. Date: Jul. 3, 2025

(54) AI-GENERATED DATASETS FOR AI MODEL TRAINING AND VALIDATION

(71) Applicant: MICROSOFT TECHNOLOGY LICENSING, LLC, Redmond, WA (US)

(72) Inventors: Matthew S. ROSOFF, Seattle, WA (US); Taylor P. SPANGLER, Redmond, WA (US); Lukas Noble DAUTERMAN, Redmond, WA (US); Scott N. ROSOFF, Seattle, WA (US); Steve Ku LIM, Redmond, WA (US); Kashyap M. PATEL, Bellevue, WA (US); Giovanni Emilio FERIOLI, Alexandria, VA (US)

(21) Appl. No.: 18/401,186

(22) Filed: Dec. 29, 2023

(51) Int. Cl. G06V 30/413; G06F 40/20

(52) U.S. Cl. CPC G06V 30/413; G06F 40/20

(57) ABSTRACT

Disclosed are techniques for synthesizing large amounts of human-computer interaction data that is representative of real-world user data. An automated screenshot capture engine may cause an automated agent to use an application or a website in a manner designed to mimic real-world human-computer interaction. Screenshots are captured to record how a user might interact with the application. Metadata, such as window location and size, may be obtained for each screenshot. Screenshots and corresponding metadata may be automatically annotated with a large language model to indicate the context of the application and/or computer system when the screenshot was captured. Data created in this way may be used to validate AI-based software application features or to train (or retrain) a machine learning model that predicts human-computer interactions. Automated synthesis of training data significantly increases the scale of data that can be obtained for training while also reducing computing and financial costs.

### BACKGROUND

One of the main challenges when developing AI-based software is acquiring sufficient data for training and validation. There are different barriers to obtaining training data for different types of machine learning models. For example, some machine learning models are used to predict human-computer interactions. Actual human-computer interactions engaged in by real-world computer users may not be preferred for training data, for example due to respect for user privacy and/or copyright. The paucity of training data for human-computer interaction-based models limits the accuracy and effectiveness of these models.

It is with respect to these and other considerations that the disclosure made herein is presented.

### SUMMARY

Disclosed are techniques for synthesizing large amounts of human-computer interaction data that is representative of real-world user data. An automated screenshot capture engine uses an application or a website in a manner designed to mimic real-world human-computer interaction. Screenshots are captured to record how a user might interact with the application. Metadata, including application window location, application window dimensions, application window title, and captions of images displayed within the application window, may be obtained for each screenshot. Screenshots and corresponding metadata may be automatically annotated, such as with a large language model, to indicate the context of the application and/or computer system when the screenshot was captured. Data created in this way may be used to validate AI-based software application features or to train (or retrain) a machine learning model that predicts human-computer interactions. Automated synthesis of training data significantly increases the scale of data that can be obtained for training while also reducing computing and financial costs.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a system for automated screenshot capture and annotation.

FIG. 2 illustrates evaluating screenshot annotation quality.

FIG. 3 illustrates a crawling pipeline for obtaining screenshots.

FIG. 4 is a flow diagram of an example method for annotating a screenshot.

FIG. 5 is a flow diagram of an example method for validating a feature of an application based on a label grade of an annotation exceeding a threshold.

FIG. 6 shows a computer architecture diagram of a computing device capable of implementing aspects of the techniques and technologies presented herein.

### DETAILED DESCRIPTION

The disclosed embodiments synthesize human-computer interaction data. Computing and financial costs are minimized or reduced by removing many if not all manual steps. This contrasts with traditional methods of data collection for model training, which tend to be time-consuming and expensive. For instance, in the case of developing facial recognition software, acquiring images of people's faces and annotating them incurs significant costs. These expenses arise from the manual collection of data as well as manually labeling the data. Both of these steps contribute substantially to overall development costs.

To address these problems, aspects of the disclosed technology are directed to an intelligent, automated, synthetic data generation and annotation system. In some embodiments, an application is controlled by an automated agent. Screenshots of application window(s) rendered by the application are captured before, during, or after the automation. The screenshots are labeled automatically and then validated automatically before being used to train a machine learning model. For example, screenshots that represent human-computer interaction may be used to validate or train (or retrain) a machine learning model that is configured to understand and/or predict what is happening on a computer screen.

The result of automated data synthesis, collection, and annotation is a large corpus of training data that can be produced quickly and at a much lower cost than manually collected or manually annotated data. The generated training data allows application developers and model engineers to quickly and efficiently test new features and train new AI models. For example, an application may use a model trained with the generated data to infer what a user is doing on their computer at a given point in time. For instance, the model may infer from a live screenshot whether the user is researching a topic, shopping, or some other activity. A more personalized application experience is made possible with this understanding.

In some configurations, screenshots are obtained as an automated agent navigates to websites in a way that mimics individual and/or aggregated usage statistics. For example, a search engine obtains statistics about web sites, such as which websites users tend to visit, the order in which they are visited, and actions that users take on various websites. Other statistics may be leveraged, including knowledge of which types of users (e.g., based on demographic data) visit which types of websites. Based on this data, an automated agent may navigate to websites congruent with real-world user activity and associated screenshots may be captured.

Screenshots may also be obtained in association with applications that are not web browsers, such as gaming applications, productivity applications, coding applications, etc. An automated screenshot capture engine may launch one or more of these applications. The automated agent may optionally perform a number of actions before, during, or after taking a screenshot. Documents, such as word processing documents or other productivity suite documents, may be obtained from the public internet, corporate file systems, or other sources. In some configurations, a selection of curated documents may be assembled by a model engineer. The automated screenshot capture engine may open one of these documents before taking a screenshot.

In some configurations, a screen region detection engine identifies regions of interest in a screenshot. A region of interest is a portion of the screenshot that may be used to understand what the user was doing—what activity they were engaged in, what goals they may have, what they are likely to do next, etc. For example, the screen region detection engine 120 may identify images, text, videos, animations, 3D renderings, or other types of content within a screenshot. Screen region detection engine 120 may also distinguish substantive regions of screenshot 108 from user interface elements such as menus, scroll bars, etc. Each type of content may be processed further into a format used for training. For example, images may be captioned, yielding machine-readable text that describes each image. Regions of text may be summarized with a large language model.

In some configurations, metadata is obtained when each screenshot is taken. Metadata may consist of application size and/or dimensions, application window location, captions of images displayed within the application window, information about related applications, language identification, etc.

The screenshot, regions of interest, information obtained by processing regions of interest (e.g. image captions, text summarizations), and/or metadata is used to generate labeled screenshots. Labeled screenshots may be used to train (or retrain) a foundation model or for validating features of a software application that uses such a model.

One example of an AI-based application that utilizes the disclosed embodiments is an application that allows the user to search for prior interactions they have had with a computing device. The application may use a semantic interaction record to find and restore a previous state of the computing device. A machine learning model trained on annotated screenshots generated by the disclosed embodiments may be used to validate the effectiveness of searching the semantic interaction record. For example, a search for “Christmas shopping” may return a screenshot of an online shopping website. The machine learning model trained with data generated by the disclosed embodiments may be leveraged to confirm that the search result is in fact a screenshot of “Christmas shopping”. Annotated screenshots may also be used to train (or retrain) the model underlying the search of the semantic interaction record. The words ‘annotation’ and ‘label’ are used interchangeably throughout this document.

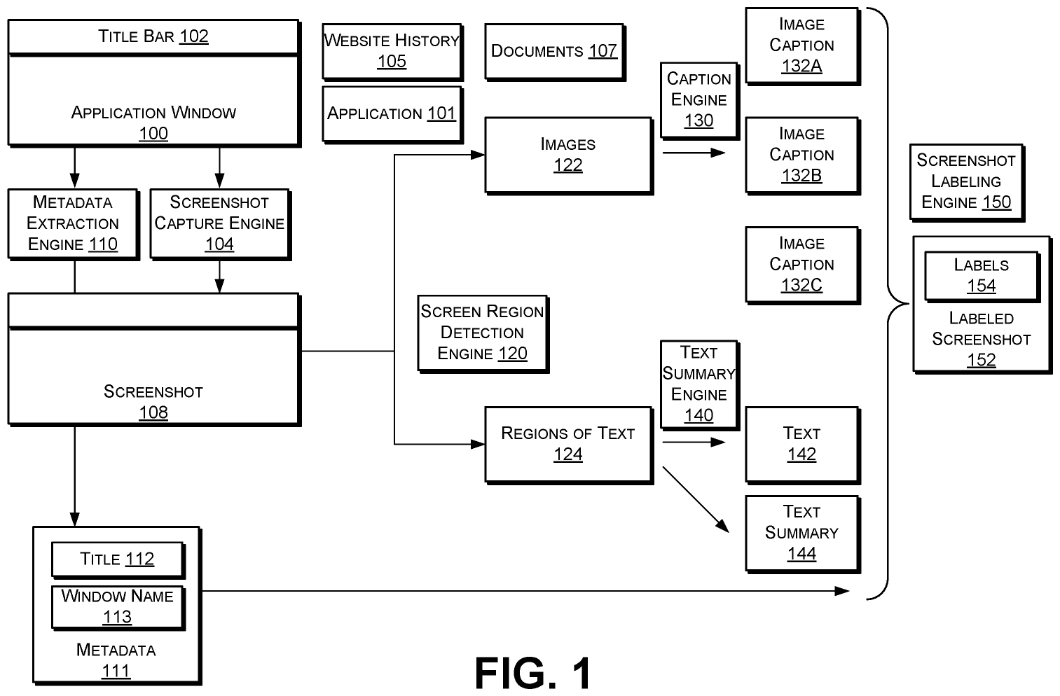

FIG. 1 illustrates a system for automated screenshot capture and annotation. Application window 100, rendered by application 101, may optionally include title bar 102. Application window 100 may be accessed by screenshot capture engine 104 and metadata extraction engine 110. Screenshot capture engine 104 captures screenshot 108 of application window 100. Metadata extraction engine 110 captures metadata 111 of application window 100 and/or application 101, such as window title 112, window name 113, dimensions and location of application window 100, etc. Metadata 111 may be stored as a tree of user interface (UI) elements—a hierarchy of information about multiple applications and application windows captured when screenshot 108 was taken. Screenshot capture engine 104 may be part of an operating system or third party application for taking screenshots. Screenshot 108 may be of a portion of application window 100 or the entirety of application window 100. Screenshot 108 may include other application windows that partially obscure application window 100 (or which application window 100 partially obscures), or screenshot 108 maybe of only application window 100. In some configurations, screenshot 108 is of an entire display or multiple displays or an entire desktop, not just a single application window.

In some configurations, screenshot capture engine 104 launches and/or automatically interacts with application window 100 in a way that mimics real-world usage patterns. Automatically mimicking real-world usage patterns enables creation of useful, relevant training data. One way in which screenshot capture engine 104 mimics real-world usage patterns is by loading real-world documents 107 into application 108. Another way in which screenshot capture engine 104 mimics real-world usage patterns is by automating application 101 in a manner consistent with aggregate usage data.

For example, screenshot capture engine 104 may navigate application window 100 to a website listed in website history 105. Website history 105 may be a list of websites visited by users. Website history 105 may also be a list of websites generated by a large language model or a multimodal model. In some configurations, website history 105 may include finer-grained usage statistics, such as which URLs users tend to visit within a particular website, the order in which URLs tend to be visited, etc. These statistics may be aggregated from real-world users in a manner that respects privacy.

For example, a particular website may have a URL that is commonly invoked, such as a “search” or “products” URL. Screenshot capture engine 104 may use an automated agent to mimic real-world usage patterns by automatically activating this URL. Other statistics, such as which websites are most often visited next, etc., may similarly be used to control application window 100 before capturing another screenshot 108.

In some configurations, screenshot capture engine 104 restricts screenshot 108 to an active portion of application window 100 that a user is able to interact with. For example, if a dialog box is presented to the user, thereby preventing the user from interacting with portions of the application that are not part of the dialog box, then screenshot 108 may be of the dialog box alone. The active portion of application window 100 may change as the state of application 101 changes.

In some configurations, screenshot capture engine 104 generates a number of related screenshots referred to as an activity set. The screenshots may be related, for example, because they were taken in sequence while automating a workflow. Screenshots may also be related after they have been labeled based on having a shared label. Activity sets may be used to validate application features or to train machine learning models as are individual labeled screenshots.

In some configurations, metadata extraction engine 110 extracts information about application window 100. Metadata extraction engine 110 may extract this information from screenshot 108, the operating system on which application window 100 is running, application 101, and/or application window 100 itself. For example, metadata extraction engine 110 may extract the dimensions and location of application window 100, text from title bar 102, information about a user account associated with application 101, etc. Text from title bar 102 may include title 112. For example, the card game “solitaire” may have the text “Solitaire” in the title bar; a word processor may include the name of a currently open document in the title bar; and a web browser may include a website name, description, or Universal Resource Locator (URL) in the title bar.

Screen region detection engine 120 analyzes screenshot 108 to isolate images 122 and regions of text 124 within screenshot 108. Examples of images 122 within screenshot 108 are images of products that are for sale, images of a news event, or other content that likely was captured by a camera, illustrated, or otherwise in pictorial form. Often, such as when application 101 is a web browser, the portion(s) of screenshot 108 that screen region detection engine 120 identifies as images 122 may be stored as separate image files, such as. jpg files, and may be included in a website using an “img” tag or equivalent. Screen region detection engine 120 may omit scroll bars, menus, buttons, and other non-distinguishing graphics content from images 122. Screen region detection engine 120 may be implemented with a machine learning model trained to detect different types of content in screenshot 108.

Regions of text 124 identified by screen region detection engine may include text that appears in a paragraph, such as in a word processing document, a news article, or a description of a product that is for sale. Text 124 may also appear within user interface elements of application window 100, such as text boxes. Identifying text within such user interface elements enables understanding of what a user was doing, such as filling out an address form, searching for airfare, or selecting a number of copies to make. Text 124 may also be identified in table form, such as in a spreadsheet, database, or other application that displays structured data.

Caption engine 130 processes one or more images 122 to generate image captions 132A-C. Caption engine 130 may employ a machine learning model trained to annotate images to generate image captions 132. For example, caption engine 130 may create image caption 132 that describes a picture of a dog as a dog, the breed of the dog, what the dog is doing, etc.

Text summary engine 140 analyzes regions of text 124 to generate text 142 and corresponding text summary 144. Text summary engine 140 may employ optical character recognition (OCR) to extract text 142 from regions of text 124. In some configurations, regions of text 124 may be read directly from application 101, e.g., by using screen reader or other accessibility technology. Text summary engine 140 may use a machine learning model to summarize text 142 into text summary 144.

Screenshot labeling engine 150 receives image captions 132, text 142 and corresponding summaries 144, and title 112. Screenshot labeling engine 150 may provide this input to a large language model to generate labels 154 of screenshot 108. Labels 154 are descriptions of the content of screenshot 108. Labeled screenshot 152 refers to screenshot 108 in combination with labels 154, one or both of which may be used as input when training a large language model that understands what a user is doing on their computing device.

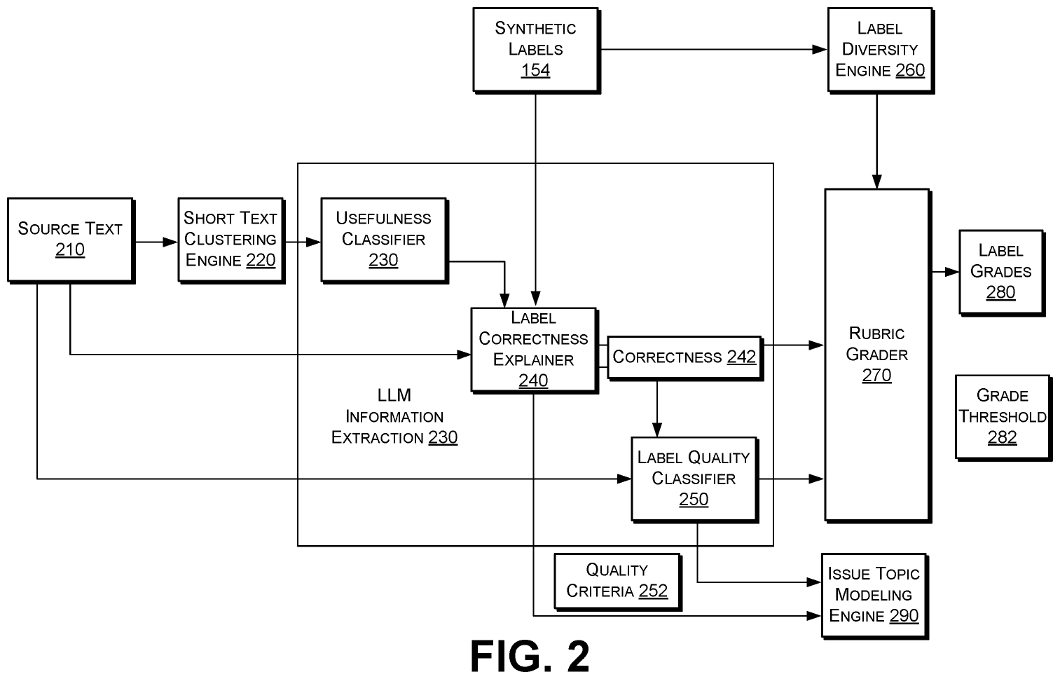

FIG. 2 illustrates evaluating screenshot annotation quality. The evaluation begins by optionally providing source text 210 to short text clustering engine 220. Source text 210 may include text 142 and corresponding text summary 144 of any identified regions of text 124 of screenshot 108. Source text 210 may also include image captions 132. For example, text 142 of source text 210 may be:
original_text=‘the in focus app is BrowserA., Would you like to pin BrowserA Browser to your taskbar? installer.exe would like to pin BrowserA Browser to the taskbar., Good morning! October 11. Last chance for Shopping Deal Days event!,. 1. CountryX 6. Global War 2. Famous Figure Skater 7. Famous Actress 3. Baseball Team Hou . . . 8. Baseball Team 2 4. Presidential Candidate 9. US Representative 5. Shopping Day must-buys 10. Speaker of the Hou Trending now 1. CountryX 2. Famous Figure Skater 3. Baseball Team 4. Presidential Candidate 5. Shopping Day must-buys, EP Apps x . . . Would you like to pin BrowserA Browser to your taskbar? installer.exe would like to pin BrowserA Browser to the taskbar. Yes No thanks, Trending now 1. CountryX 6. Global War 2. Famous Figure Skater 7. Famous Actress 3. Speaker of the Hou . . . 8. Baseball Team 2 4. Presidential Candidate 9. US Representative 5. Shopping Day must-buys 10. Baseball Team A, VPN search. yahoo!, a red circle with white background, a red circle with a white background, Shopping Deal Days Event, CountryX, Global War, Presidential Candidate, BrowserA Browser Installer Notifications’

Short text clustering engine 220 clusters source text 210 and outputs the result to usefulness classifier 230. Clustering text helps to identify key related topics in screen text 142 so that key topics are more easily identified.

Usefulness classifier 230 determines which portions of text 142 are good candidates to determine whether synthetic labels 154 correctly describe them. Examples of good candidates include text contained in a news article, a search result, or the description of a piece of music. Examples of text that would not be good candidates include gibberish, code, strings of text that aren't human readable, etc. In some configurations, usefulness classifier 230 may generate one of two labels for a portion of text: readable and usable or unreadable and unusable. Additional classifiers that identify a degree of usability, and which identify sub-classes of usable or unusable text, are similarly contemplated.

Label correctness explainer 240 receives source text 210, the output of usefulness classifier 230, and synthetic labels 154. From these inputs, label correctness explainer 240 makes correctness inferences 242 about whether a label 154 is correct or incorrect based on whether it is supported by the source text 142. Label correctness explainer 240 may evaluate portions of text 142 deemed useful by usefulness classifier 230 while ignoring portions of text 142 that are gibberish or random strings. One example of a set of labels that were derived from the example source text listed above is:
labels=[browsing Application Store Deals on BrowserA, researching CountryX and Global War, reading Presidential Candidate articles, downloading BrowserA Browser Installer, viewing images of a red circle, checking weather updates on BrowserA]

Label correctness explainer 240 may identify labels as being correct, incorrect, or missing. Correct labels may further be classified as explicitly or implicitly correct, while incorrect labels may similarly be classified as explicitly incorrect or implicitly incorrect. Label correctness explainer 240 may also identify labels that are missing. A label is missing if text in text 142 is not accounted for by one of labels 154. Continuing the example, label correctness explainer 240 may emit output like the following:

```
response = {
‘correct’:
    ‘explicit’: {
        “1”: “The text mentions ‘Country X’ and ‘Global War’, directly supporting the label.”,
        “2”: “The text mentions ‘Presidential Candidate’, directly supporting the label.”,
        “3”: “The mention of ‘installer.exe’ and BrowserA Browser implies a context of downloading the browser.” },
    ‘implicit’: { },
},
‘incorrect’: {
    ‘explicit’: {
        “0”: “The text mentions ‘Shopping Deal Days event’ and not ‘Application Store Deals’.”,
        “5”: “There is no mention of ‘weather updates’ in the provided text.” },
    ‘implicit’: {
        “4”: “The mention of ‘a red circle with white background’ doesn’t indicate it’s being viewed as an image in
        BrowserA, but could be misinterpreted as such.” }, },
‘missing’: {
    “0”: “There is a mention of ‘Shopping Deal Days event’ which is not represented in any of the provided labels.”,
    “1”: “Mention of pinning ‘BrowserA Browser to your taskbar’ is also not represented in the labels.” }
}
```

Label quality classifier 250 receives the output of label correctness explainer 240 and source text 210. Label quality classifier 250 determines whether a label 154 that was deemed correct will also be useful for understanding the automated user behavior that led to screenshot 108. A label that is concrete, and which is solidly grounded in the source text, is more likely to meet quality criteria 252. A vague label that is more difficult to interpret is more likely to be considered low quality, and as such would not meet quality criteria 252. An example of a vague correctness explainer output is an explainer that is abstracted too much from the original text. In some configurations, label quality classifier 250 emits a binary score for each label, such as “high quality” or “low quality”. In other configurations, multiple discreet quality measures and/or continuous quality measures are similarly contemplated.

In the example label correctness explainer 240 output, label quality classifier 250 may determine that the first two explicitly correct labels are high quality because they are solidly grounded in the source text. However, the third explicitly correct label may be deemed low quality because it is too abstract, or because it is not as well grounded in the original text.

In some configurations, rubric grader 270 is a deterministic function that takes in information extracted from the previous steps and calculates a numeric label grade 280 that is assigned to the screenshot. If the label grade 280 exceeds grade threshold 282, the labeled screenshot 152 associated with source text 210 may be used to validate an application feature or train (or retrain) a machine learning model. For example, rubric grader 270 may generate a grade by taking a number of labels that were identified as ‘correct’ by label correctness explainer 240, adding a number of labels identified by label quality classifier 250 as meeting quality criteria 252, and adding a label variance, discussed below.

Label diversity engine 260 evaluates a diversity of labels 154—a measure of how different labels 154 of a particular screenshot 108 are from each other. Labels for a particular screenshot receive a higher grade if there is greater diversity among labels 154. In other words, if five labels 154 are generated for screenshot 108, and the five labels are more or less the same, these labels are deemed less useful than if there was variation between them. In some configurations, embeddings of each of labels 154 are computed, and a label_variance is computed as the sum of the distances of each pair of embeddings.

Issue topic modeling engine 290 receives as input explanations generated by components such as label correctness explainer 240 and label quality classifier 250. See, for instance, the example output of label correctness explainer 240 listed above, which explains why a label is correct or incorrect for the source text 210. These explanations may be for multiple labels 154 and multiple screenshots 108. Issue topic modeling engine 290 attempts to identify trends or patterns in these explanations. In some configurations, issue topic modeling engine 290 passes the explanations through a topic modeling process to produce clusters of explanations of things that went wrong. This may aid a user in understanding how to address the underlying problem.

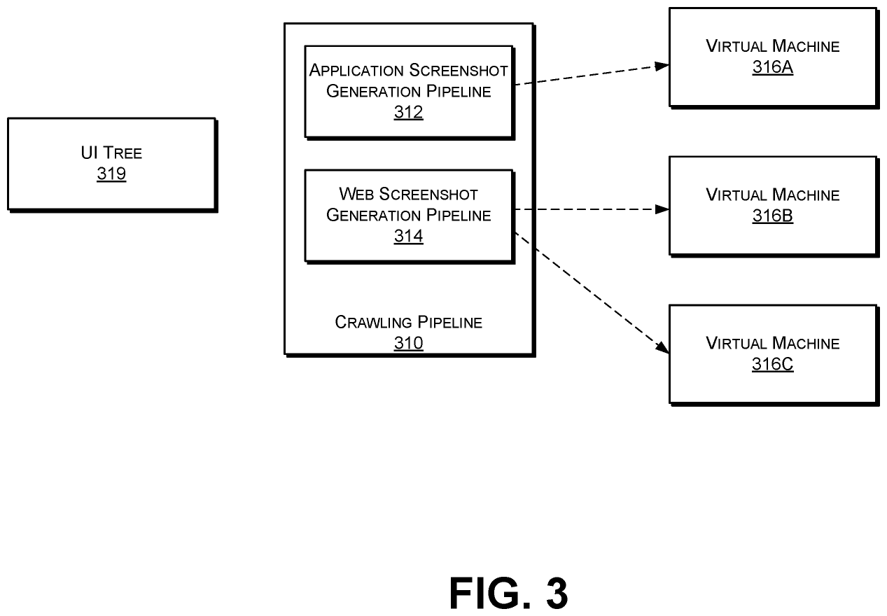

FIG. 3 illustrates a crawling pipeline for obtaining screenshots. Crawling pipeline 310 includes application screenshot capture pipeline 312 and web screenshot capture pipeline 314. Application screenshot capture pipeline 312 is directed towards obtaining screenshots from games, productivity applications, and other operating system or third party applications that run natively on the host operating system. Web screenshot capture pipeline 314 is directed towards obtaining screenshots from a web browser. Some functionality may be shared between application screenshot capture pipeline 312 and web screenshot capture pipeline 314. Application screenshot capture pipeline 312 may obtain documents 107 that were made publicly available, from an internal repository, or other source.

Application screenshot capture pipeline 312 and web screenshot capture pipeline 314 each may launch one or more virtual (or physical) machine instances 316A-C with which to capture screenshots 108. Application screenshot capture pipeline 312 may launch one or more applications 100, optionally opening one or more documents 107. As referred to herein, a document contains user-generated content that can be viewed, edited, or otherwise manipulated by an application. Examples of documents include spreadsheets, text files, source code files, web pages, web sites, images, and the like.

Web screenshot capture pipeline 314 may open a web browser and navigate to one of the websites stored in website history 105. Web screenshot capture pipeline 314 may optionally navigate to a particular page of a website, perform actions commonly taken on a particular website such as submitting a form, or perform other actions that simulate real-world user interaction with the website.

Both pipelines may optionally manipulate the application that opens the content, such as scrolling through the opened content, clicking on buttons, menus, or otherwise activating user interface elements, adding or editing content, etc. Both pipelines then wait for content to be rendered to screen before taking screenshot 108.

In some configurations, in addition to screenshot 108, metadata 111 about screenshot 108 is also obtained and recorded. Metadata 111 may include a URL in the case of web screenshot capture pipeline 314, or an application and/or document name for application screenshot capture pipeline 312.

In some configurations, web screenshot capture pipeline 314 performs error checking on screenshot 108. For example, web screenshot capture pipeline 314 may automatically exclude screenshots indicating that the requested content was not found. For example, a web page that indicates a ‘404—page not found’ error, or equivalent, may be discarded without further processing. Similarly, application screenshot capture pipeline 312 may identify and dismiss dialog boxes that would otherwise interfere with running application 101 on virtual machine 316.

In some configurations, the screenshot capture pipelines 312 and 314 may configure application window 100 to use one of a number of user interface themes. For example, a “dark mode” may be selected to improve contrast of key elements. The screenshot capture pipelines may switch among different user interface themes, as well as different default languages, in order to broaden type of content contained in screenshot 108. Additionally, or alternatively, the screenshot capture pipelines 312 may adjust the resolution of screenshot 108 in order to obtain training data of different resolutions.

In some configurations, application screenshot capture pipeline 314 has access to automation tools that load applications 101, open documents 107 in those documents, and navigate around the user interfaces of loaded application window 100. Application screenshot capture pipeline 314 may use one of these automation tools to obtain screenshots of usage data that would otherwise be expensive to obtain, if it could be obtained at all.

Screenshot capture pipelines 312 and 314 may have access to a very large number of documents that could be opened or URLs that could be visited, respectively. In some configurations this work is parallelized by splitting a list of potentially millions of URLs into more manageable sized lists of hundreds or thousands of URLs. In some configurations, each list of URLs is built into an executable file that implements web screenshot capture pipeline 314 for the URLs. These executable files may then be distributed to a collection of virtual machines 316 for execution in parallel. Application screenshot capture pipeline 312 may similarly bundle manageable numbers of applications and documents to open into a list which is compiled into an executable file, such as an .exe or a .dll, and deploying them to virtual machines 316 for execution.

In some configurations, virtual machines 316 are established with a variety of settings, diversifying the data that is captured. For example, virtual machine 316A may be set up with a particular language, which may affect the language of content rendered by one of the website targets, and so affect the language captured by screenshot 108. Similarly, virtual machine 316B may be established with a variety of screen resolutions, themes, and other visual elements that affect screenshot 108.

In some configurations, in addition to capturing screenshot 108, screenshot capture pipelines 312 and 314 capture a UI tree 319 that represents, for example, what applications were open on the desktop when the screenshot 108 was taken. In some configurations, UI tree 319 indicates which tabs a web browser had open when screenshot 108 was taken. UI tree 319 may be stored as part of metadata 111.

UI tree 319—which may be part of metadata 111—may be navigated up, towards the root, for example, from a tab of a web browser in order to obtain data about the web browser itself. UI tree 319 may also be traversed down, for example, to learn about elements in the web page such as buttons, scroll bars, images, and other windows or controls. In some configurations, screenshot capture pipelines 312 and 314 may capture a screenshot of an entire desktop or an entire display. Metadata contained in UI tree 319 enables cropping the screenshot to particular applications and even to particular windows.

In some configurations, UI tree 319 includes text descriptions of elements such as application windows, controls, panes, images, etc. The text description may come from a “name” attribute of a UI element. UI tree 319 may also include title 112 of application 108. Additionally, or alternatively, the text description may come from an “alt” attribute included in the img tag. This text may, in some configurations, be provided to screenshot labeling engine 150 for incorporation into label 154. In some configurations, web screenshot capture pipeline 314 may obtain metadata 111 in part from a document object model (DOM), which may know in real time where different types of content are being displayed.

Metadata gathered or otherwise obtained while taking screenshot 108 may include a list of labels 154 associated with screenshot 108. For example:

```
  “labels”: {
    “v3”: {
      “search_annotations”: [
        “purchasing affordable sunglasses”,
        “adding sunglasses to cart”,
        “shopping for themed sunglasses”,
        “exploring pricing of sunglasses”,
        “online shopping for sunglasses”
      ],
      “topic_annotations”: [
        “sunglassessite.com”,
        “affordable sunglasses”,
        “online shopping”,
        “pricing”,
        “Add to Cart”
      ],
      “intent_annotations”: “The response will look something like this: \n\n\n\n { \“query\”:
[\“Sungla...”
  }
```

In this example, labels 154 are divided into different types of labels, such as “search_annotations”, “topic_annotations”, and “intent_annotations.” Different types of labels may be obtained by adjusting the machine learning model prompts used by screenshot labeling engine 150 when inferring labels 154 of screenshot 108. Search annotations may refer to what a user was doing, such as purchasing sunglasses. Topic annotations may refer to what the user was doing at a higher level, e.g., “affordable sunglasses” and “add to cart”. Intent annotations refer to a more detailed explanation of what the user was doing, optionally synthesizing what the user was doing as described by the different search annotations.

As discussed above, annotated screenshots may be used as test data for application or operating system features or for model training. One example is a semantic screen interaction search feature that takes screenshots of a computing device over time, recording user interactions, and allowing a user to search for past states of their computer. Labeled screenshots 152 may be used to test this feature by using the “search_annotation” labels of labels 154 as a search query, and corresponding screenshot 108 to confirm that the search result is correct. Similarly, the “topic_annotation” label is generated so that an application can search through user history and group user interactions, as captured by screenshots, by topic. Other types of labels, intended for other types of applications or models, are similarly contemplated.

In general, data—e.g. screenshots and associated metadata—is collected that approximates what users do with their computer. Then, annotations are created that simulate what the feature is trying to accomplish. For example, “search_annotation” labels are created so that the above-reference semantic screen interaction search feature has appropriate data to search through.

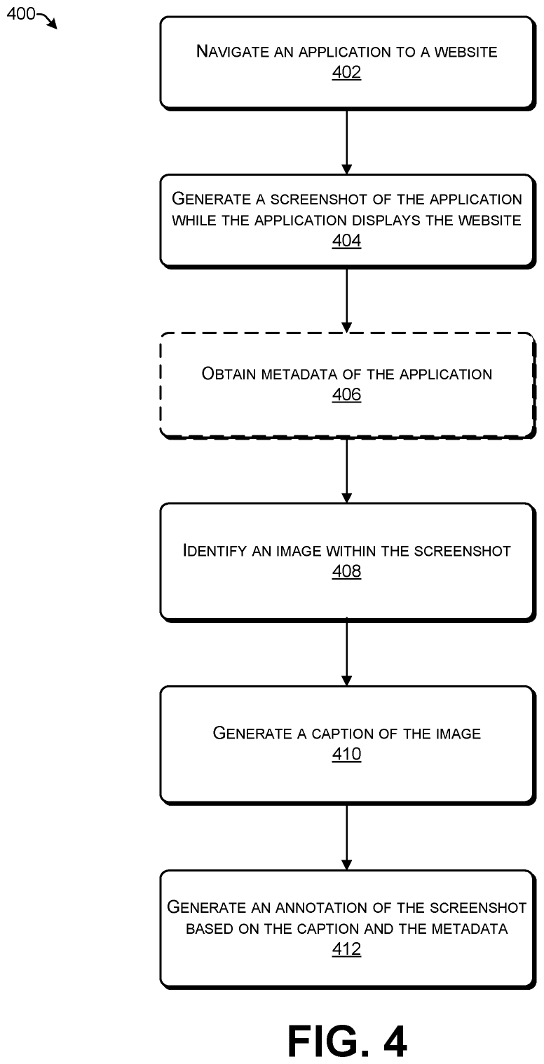

FIG. 4 is a flow diagram of an example method for annotating a screenshot.

Routine 400 begins at operation 402, where screen capture engine 104 navigates application window 100 to a website selected from websites 105.

Next at operation 404, screenshot capture engine 104 takes a screenshot 108 of application window 100.

Next at operation 406, metadata extraction engine 110 optionally obtains metadata 111, such as a UI tree 319, as described above in conjunction with FIG. 3

Next at operation 408, screen region detection engine 120 identifies image 122 within screenshot 108. Screen region detection engine 120 may also identify regions of text 124.

Next, at operation 410, caption engine 130 generates caption 132 from image 122.

Next, at operation 412, screenshot labeling engine 150 accepts image caption 132, text 142, text summary 144, and metadata 111 to generate labels 154 of labeled screenshot 152.

As referred to herein, a machine learning model is a computational system designed to perform a specific task by learning patterns from data. At its core, it comprises algorithms that can analyze and interpret data, learn from it, and make decisions or predictions based on this learning. These models are trained using datasets, wherein they adjust their internal parameters to minimize errors in their outputs compared to known examples.

Machine learning models can be categorized into various types based on their learning approach. These include supervised learning, where the model learns from a labeled dataset; unsupervised learning, where it identifies patterns in unlabeled data; and reinforcement learning, where it learns through feedback from interactions with an environment.

Common architectures of machine learning models include neural networks, decision trees, support vector machines, and regression models. The complexity and structure of these models can vary greatly depending on the task, ranging from simple linear models to complex deep learning networks.

A Large Language Model (LLM) is a type of machine learning model specifically designed to understand, generate, and manipulate human language. These models are typically built using deep learning techniques, particularly neural networks like transformers, which have a large number of parameters allowing them to capture complex language patterns. LLMs are trained on vast datasets of text, enabling them to learn a wide range of linguistic structures, idioms, and styles.

LLMs perform tasks such as text generation, translation, summarization, question answering, and sentiment analysis. The training process involves adjusting the model's parameters to minimize the difference between its outputs and the expected results, typically using techniques like supervised learning. The effectiveness of LLMs depends on the diversity and size of the training data, as well as the sophistication of their architecture. They are widely used in applications like virtual assistants, content creation tools, language translation services, and customer support automation.

Multimodal models are a class of machine learning models designed to process and relate information from multiple types of data inputs, such as text, images, audio, and video. These models integrate different types of data processing architectures—like convolutional neural networks for image analysis and recurrent neural networks for text processing—to understand and generate complex data representations.

The primary objective of a multimodal model is to capture correlations and interactions between different types of data, enabling it to perform tasks that involve multiple sensory modalities. For instance, a multimodal model might analyze both the text and images in a social media post to understand its sentiment and context, or it might generate a descriptive caption for a photograph.

Multimodal models are trained using datasets containing diverse types of data, and they learn to associate the information from these different modalities effectively. The complexity of multimodal models lies in their ability to accurately process and integrate disparate data forms. They are used in applications like automated content moderation, interactive AI systems, accessible technology for the visually or hearing impaired, and advanced user interface design.

Screen region detection engine 120, caption engine 130, text summary engine 140, screenshot labeling engine 150, short text clustering engine 220, usefulness classifier 230, label correctness explainer 240, label quality classifier 250, label diversity engine 260, issue topic modeling engine 290, and other engines/models discussed herein, may utilize one or more machine learning model.

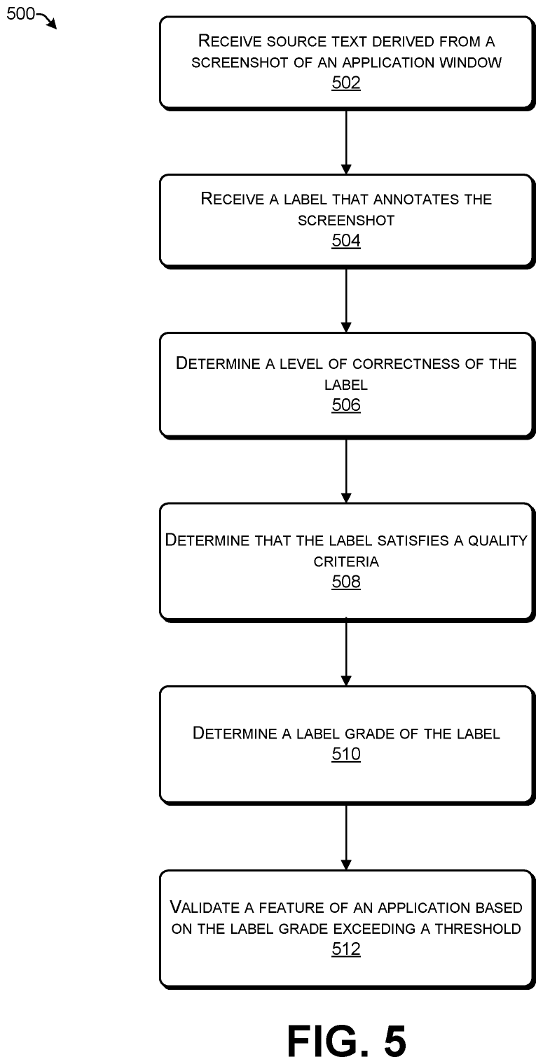

FIG. 5 is a flow diagram of an example method for validating a feature of an application based on a label grade of an annotation exceeding a threshold.

Routine 500 begins at operation 502, where source text 210 is received. Source text may include captions 132, text 142, text summary 144, and any other text extracted from application window 100 or screenshot 108.

Next at operation 504, one or more labels 154 that annotate screenshot 108 are received.

Next at operation 506, label correctness explainer 240 uses a machine learning model to determine level of correctness 242 for one or more labels 154 and corresponding source text 210.

Next at operation 508, label quality classifier 250 determines whether labels 154 satisfy quality criteria 252.

Next, at operation 510, rubric grader 270 determines label grades 280 for labels 154.

Next, at operation 512, a feature of an application is validated with labeled screenshot 152 based on whether the label grade 280 generated by rubric grader 270 exceeds a threshold 282. Additionally, or alternatively, a machine learning model is retrained or trained using labeled screenshot 152 based on whether label grade 280 exceeds threshold 282.

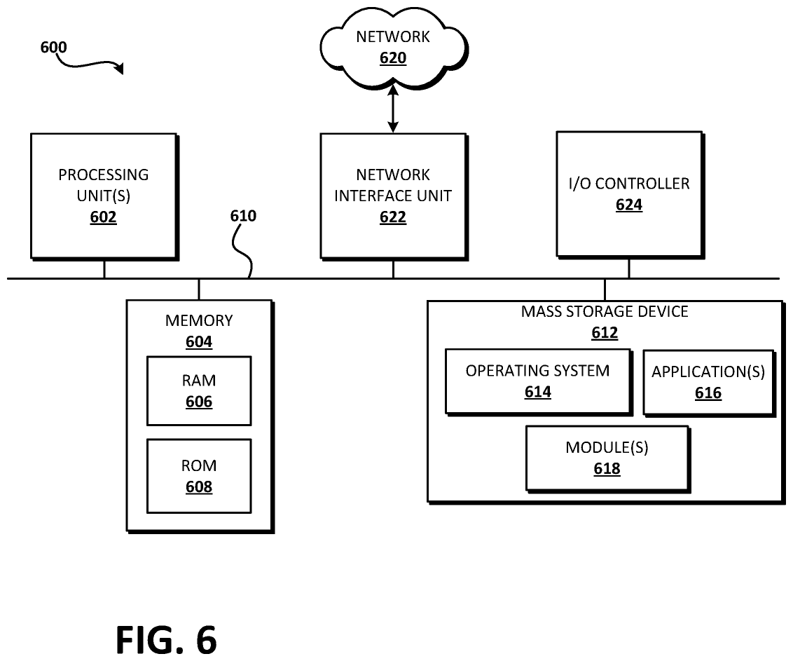

FIG. 6 shows additional details of an example computer architecture 600 for a device, such as a computer or a server configured as part of the systems described herein, capable of executing computer instructions (e.g., a module or a program component described herein). The computer architecture 600 illustrated in FIG. 6 includes processing unit(s) 602, a system memory 604, including a random-access memory 66 (“RAM”) and a read-only memory (“ROM”) 608, and a system bus 610 that couples the memory 604 to the processing unit(s) 602. The processing unit(s) 602 include one or more hardware processors and may also comprise or be part of a processing system. In various examples, the processing unit(s) 602 of the processing system are distributed. Stated another way, one processing unit 602 may be located in a first location (e.g., a rack within a datacenter) while another processing unit 602 of the processing system is located in a second location separate from the first location.

Processing unit(s), such as processing unit(s) 602, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein. 6

The mass storage device 612 is connected to processing unit(s) 602 through a mass storage controller connected to the bus 610. The mass storage device 612 and its associated computer-readable media provide non-volatile storage for the computer architecture 600. Although the description of computer-readable media contained herein refers to a mass storage device, it should be appreciated by those skilled in the art that computer-readable media can be any available computer-readable storage media or communication media that can be accessed by the computer architecture 600.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

It should be appreciated that the software components described herein may, when loaded into the processing unit(s) 602 and executed, transform the processing unit(s) 602 and the overall computer architecture 600 from a general-purpose computing system into a special-purpose computing system customized to facilitate the functionality presented herein. The processing unit(s) 602 may be constructed from any number of transistors or other discrete circuit elements, which may individually or collectively assume any number of states. More specifically, the processing unit(s) 602 may operate as a finite-state machine, in response to executable instructions contained within the software modules disclosed herein. These computer-executable instructions may transform the processing unit(s) 602 by specifying how the processing unit(s) 602 transition between states, thereby transforming the transistors or other discrete hardware elements constituting the processing unit(s) 602.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

### Illustrative Embodiments

The following clauses describe multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Example 1: A method, comprising: generating a screenshot of an application window; identifying an image within the screenshot; generating a caption of the image; and generating an annotation of the screenshot based on the caption of the image.

Example 2: The method of Example 1, further comprising: identifying a region of text within the screenshot; extracting text from the region of text; and generating the annotation of the screenshot based on the extracted text.

Example 3: The method of Example 1, further comprising: identifying a title of the application window; and generating the annotation of the screenshot based on the identified name.

Example 4: The method of Example 1, further comprising: automatically navigating the application window to a website and causing an automated agent to interact with the website in accordance with a usage history of the website.

Example 5: The method of Example 1, further comprising: generating an activity set by grouping screenshots taken while causing an automated agent to individually navigate to frequently visited locations within the application window; and validating a feature or retraining a machine learning model with the activity set.

Example 6: The method of Example 1, further comprising: generating an activity set by grouping screenshots taken while causing an automated agent to navigate through a stream of locations within the application window; and validating a feature of an individual application or training a machine learning model with the activity set.

Example 7: The method of Example 1, further comprising: applying the screenshot and the annotation of the screenshot to a feature of an application; and validating the feature by comparing an output of the feature with the annotation.

Example 8: The method of Example 1, further comprising: training a machine learning model with the annotation and the screenshot.

Example 9: A system comprising: a processing unit; and a computer-readable storage medium having computer-executable instructions stored thereupon, which, when executed by the processing unit, cause the processing unit to: receive a source text derived from a screenshot of an application window; receive a label that annotates the screenshot; determine a level of correctness of the label in relation to the source text; determine that the label satisfies a quality criteria; determine a label grade of the label based on the level of correctness and the determination that the label satisfies the quality criteria; and validate a feature of an application based on a determination that the label grade exceeds a defined threshold.

Example 10: The system of Example 9, wherein the computer-executable instructions further cause the processing unit to: identify a portion of the source text that satisfies a usefulness criteria, wherein the level of correctness of the label is determined in relation to the identified portion of the source text.

Example 11: The system of Example 9, wherein the label is one of a plurality of labels, and wherein the computer-executable instructions further cause the processing unit to: compute a diversity score of the plurality of labels, wherein the label grade is additionally based on the diversity score.

Example 12: The system of Example 11, wherein the diversity score is computed based on distances between embedding scores computed for each of the plurality of labels, and wherein the label grade is proportional to the diversity score.

Example 13: The system of Example 10, wherein the source text is processed by a short text clustering engine before the portion of the source text is determined to satisfy the usefulness criteria.

Example 14: The system of Example 11, wherein the computer-executable instructions further cause the processing unit to: identify, across a plurality of labels applied to a plurality of screenshots, clusters of related explanations of label incorrectness or low label quality.

Example 15: A computer-readable storage medium having encoded thereon computer-readable instructions that when executed by a processing unit cause a system to: navigate an application to a website; generate a screenshot of an application window of the application; obtain metadata of the application; identify an image within the screenshot; generate a caption of the image; and generate an annotation of the screenshot based on the caption of the image and the metadata.

Example 16: The computer-readable storage medium of Example 15, wherein the metadata comprises a tree of properties of windows of a desktop that includes the application.

Example 17: The computer-readable storage medium of Example 15, wherein the screenshot is cropped to the application based on a location and a size of the application obtained from the metadata.

Example 18: The computer-readable storage medium of Example 15, wherein the metadata includes a description of an image displayed in the application, and wherein the annotation of the screenshot is generated in part based on the description of the image.

Example 19: The computer-readable storage medium of Example 15, wherein the annotation is generated by a large language model based on a prompt that tailors the annotated screenshot for a particular use.

Example 20: The computer-readable storage medium of Example 15, wherein the screenshot is generated by a computing device configured with a screen resolution, a language, and a user interface theme selected to create screenshots under a diversity of computing environments.

### CONCLUSION

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, references have been made to publications, patents and/or patent applications throughout this specification. Each of the cited references is individually incorporated herein by reference for its particular cited teachings as well as for all that it discloses.

What is claimed is:

1. A method, comprising:
generating a screenshot of an application window;
identifying an image within the screenshot;
generating a caption of the image; and
generating an annotation of the screenshot based on the caption of the image.

2. The method of claim 1, further comprising:
identifying a region of text within the screenshot;
extracting text from the region of text; and
generating the annotation of the screenshot based on the extracted text.

3. The method of claim 1, further comprising:
identifying a title of the application window; and
generating the annotation of the screenshot based on the identified name.

4. The method of claim 1, further comprising:
automatically navigating the application window to a website and causing an automated agent to interact with the website in accordance with a usage history of the website.

5. The method of claim 1, further comprising:
generating an activity set by grouping screenshots taken while causing an automated agent to individually navigate to frequently visited locations within the application window; and
validating a feature or retraining a machine learning model with the activity set.

6. The method of claim 1, further comprising:
generating an activity set by grouping screenshots taken while causing an automated agent to navigate through a stream of locations within the application window; and
validating a feature of an individual application or training a machine learning model with the activity set.

7. The method of claim 1, further comprising:
applying the screenshot and the annotation of the screenshot to a feature of an application; and
validating the feature by comparing an output of the feature with the annotation.

8. The method of claim 1, further comprising:
training a machine learning model with the annotation and the screenshot.

9. A system comprising:
a processing unit; and
a computer-readable storage medium having computer-executable instructions stored thereupon, which, when executed by the processing unit, cause the processing unit to:
receive a source text derived from a screenshot of an application window;
receive a label that annotates the screenshot;
determine a level of correctness of the label in relation to the source text;
determine that the label satisfies a quality criteria;
determine a label grade of the label based on the level of correctness and the determination that the label satisfies the quality criteria; and
validate a feature of an application based on a determination that the label grade exceeds a defined threshold.

10. The system of claim 9, wherein the computer-executable instructions further cause the processing unit to:
identify a portion of the source text that satisfies a usefulness criteria, wherein the level of correctness of the label is determined in relation to the identified portion of the source text.

11. The system of claim 9, wherein the label is one of a plurality of labels, and wherein the computer-executable instructions further cause the processing unit to:
compute a diversity score of the plurality of labels, wherein the label grade is additionally based on the diversity score.

12. The system of claim 11, wherein the diversity score is computed based on distances between embedding scores computed for each of the plurality of labels, and wherein the label grade is proportional to the diversity score.

13. The system of claim 10, wherein the source text is processed by a short text clustering engine before the portion of the source text is determined to satisfy the usefulness criteria.

14. The system of claim 11, wherein the computer-executable instructions further cause the processing unit to:
identify, across a plurality of labels applied to a plurality of screenshots, clusters of related explanations of label incorrectness or low label quality.

15. A computer-readable storage medium having encoded thereon computer-readable instructions that when executed by a processing unit cause a system to:
navigate an application to a website;
generate a screenshot of an application window of the application;
obtain metadata of the application;
identify an image within the screenshot;
generate a caption of the image; and
generate an annotation of the screenshot based on the caption of the image and the metadata.

16. The computer-readable storage medium of claim 15, wherein the metadata comprises a tree of properties of windows of a desktop that includes the application.

17. The computer-readable storage medium of claim 15, wherein the screenshot is cropped to the application based on a location and a size of the application obtained from the metadata.

18. The computer-readable storage medium of claim 15, wherein the metadata includes a description of an image displayed in the application, and wherein the annotation of the screenshot is generated in part based on the description of the image.

19. The computer-readable storage medium of claim 15, wherein the annotation is generated by a large language model based on a prompt that tailors the annotated screenshot for a particular use.

20. The computer-readable storage medium of claim 15, wherein the screenshot is generated by a computing device configured with a screen resolution, a language, and a user interface theme selected to create screenshots under a diversity of computing environments.
